(19) United States
(12) Patent Application Publication
(10) Pub. No.: US 2024/0202465 A1
(43) Pub. Date: Jun. 20, 2024

(54) INFORMATION PROCESSING APPARATUS, CONTROLLING METHOD OF INFORMATION PROCESSING APPARATUS, AND STORAGE MEDIUM

(71) Applicant: CANON KABUSHIKI KAISHA, Tokyo (JP)

(72) Inventor: YOSUKE IGARASHI, Chiba (JP)

(21) Appl. No.: 18/540,694

(22) Filed: Dec. 14, 2023

(30) Foreign Application Priority Data
Dec. 20, 2022 (JP) 2022-203058

(51) Int. Cl. G06F 40/47; G06T 11/20; G06T 11/60; G06V 10/94; G06V 20/70; G06V 30/19; G06V 30/30

(52) U.S. Cl. CPC G06F 40/47; G06T 11/20; G06T 11/60; G06V 10/945; G06V 20/70; G06V 30/191; G06V 30/30; G06T 2200/24

(57) ABSTRACT

An information processing apparatus according to the present disclosure acquires a translation text by executing a translation process on an input text; selects one or more consecutive characters in the translation text as a selection text, based on a user operation; assigns a label selected based on a user operation, to a character string corresponding to the selection text in the input text; and stores the input text to which the label has been assigned, in a storage unit.

### BACKGROUND

### Field

The present disclosure relates to an information processing apparatus that supports assignation of an annotation of a document image, a controlling method thereof, and a storage medium in which a program for executing the controlling method is stored.

### Description of the Related Art

Conventionally, there is a technique of reading characters in a document image, converting the read characters into an electronic file, and automatically assigning a proper file name. Elements constituting the file name to be automatically assigned include an organization name and a person name in the document, a document number, a date of issue of the document in addition to a date and time of document creation.

As a method of extracting such items, there are a method in which each item position in a document is registered in advance, and a method in which a unique expression extraction technology, which is an application technology in the field of a natural language process, is used. However, in any method, an annotation operation for inputting the type and position of an item to be extracted with respect to a document image is necessary. That is, in the former method, the annotation operation is necessary for registering the items, and in the latter method, the annotation operation is necessary for generating learning data of a machine learning model for realizing unique expression extraction. As a method for supporting such annotation, there is a technique disclosed in Japanese Patent Application Laid-Open No. 2011-248669.

An operator (hereinafter, referred to as an “annotator”) of the annotation needs knowledge about a target document and input items, and work costs of the annotation are originally high. Further, in a case where the annotator is not familiar with the language described in the document, it is necessary to carry out the annotation while performing a translation operation in the method of Japanese Patent Application Laid-Open No. 2011-248669, and the work costs greatly increase.

### SUMMARY

An information processing apparatus according to the present disclosure acquires a translation text by executing a translation process on an input text; selects one or more consecutive characters in the translation text as a selection text, based on a user operation; assigns a label selected based on a user operation, to a character string corresponding to the selection text in the input text; and stores the input text to which the label has been assigned, in a storage unit.

Further features of the present disclosure will become apparent from the following description of exemplary embodiments with reference to the attached drawings.

### BRIEF DESCRIPTION OF THE DRAWINGS

FIG. 1 is a hardware configuration diagram of an embodiment.

FIG. 2 is a software configuration diagram of the embodiment.

FIG. 3 is a process flow of the embodiment.

FIG. 4 is a diagram showing an input image and an input text area of the embodiment.

FIG. 5 is a diagram showing input texts and translation texts of the embodiment.

FIG. 6 is a diagram showing a translation image of the embodiment.

FIG. 7 is a diagram showing a display screen of the embodiment.

FIG. 8 is a flow chart of a label assigning process of the embodiment.

FIG. 9A is a diagram showing text selection and label assignation of the embodiment.

FIG. 9B is a diagram showing the text selection and the label assignation of the embodiment.

FIG. 9C is a diagram showing the text selection and the label assignation of the embodiment.

FIG. 10 is a diagram showing the text selection and the label assignation of to the embodiment.

FIG. 11A is a diagram showing the text selection and the label assignation of the embodiment.

FIG. 11B is a diagram showing the text selection and the label assignation of the embodiment.

FIG. 12A is a diagram showing the display screen after the label assigning process of the embodiment.

FIG. 12B is a diagram showing the display screen after the label assigning process of the embodiment.

FIG. 13A is a diagram showing a second embodiment.

FIG. 13B is a diagram showing the second embodiment.

FIG. 14 is a diagram showing a third embodiment.

### DESCRIPTION OF THE EMBODIMENTS

Hereinafter, embodiments of the present disclosure will be described with reference to the accompanying drawings. It should be noted that the embodiments do not limit the present disclosure, and all the configurations described in the embodiments are not necessarily essential means for solving the issues to be solved in the present disclosure.

### First Embodiment

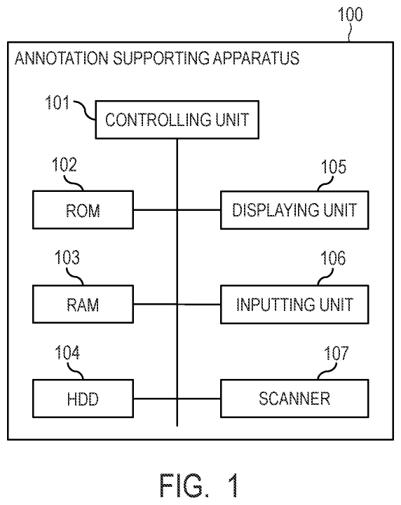

FIG. 1 is a diagram showing a hardware configuration of an annotation supporting apparatus as an information processing apparatus according to a first embodiment. An annotation supporting apparatus 100 includes a controlling unit 101, a ROM 102, a RAM 103, an HDD 104, a displaying unit 105, an inputting unit 106, and a scanner 107.

The controlling unit 101 reads out a control program stored in the ROM 102 and executes various kinds of processes.

The RAM 103 is used as a main memory, and a temporary storage area such as a work area or the like of the controlling unit 101.

The HDD 104 stores various data, various programs, and the like. Later-described functions and processes of the annotation supporting apparatus 100 are implemented by the controlling unit 101 reading out the program stored in the ROM 102 or the HDD 104 and executing the program.

The displaying unit 105 displays various kinds of information.

The inputting unit 106 includes a keyboard and a mouse, and receives various operations by a user. Note that the displaying unit 105 and the inputting unit 106 may be provided as a single unit such as a touch panel. The displaying unit 105 may perform projection by a projector. The inputting unit 106 may recognize, by a camera, the position of a fingertip with respect to a projected image.

The scanner 107 reads a paper surface and generates a scan image. The scanner 107 is not limited to a contact scanner, and a document camera or a smartphone may be used as a non-contact scanner.

In the present embodiment, the scanner 107 reads a paper document such as a business form to generate a business-form image, converts the image into text data by a later-described character recognition portion 202, and stores the converted text data in a storage device such as the HDD 104.

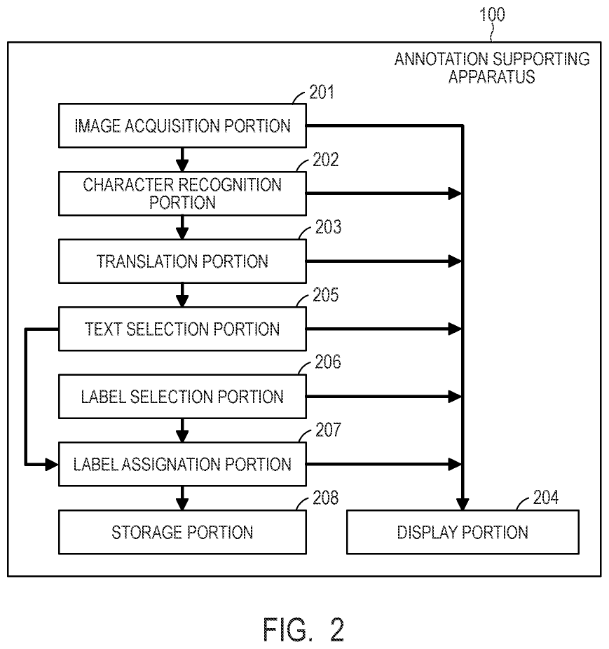

FIG. 2 is a diagram showing a software configuration of the annotation supporting apparatus 100 according to the first embodiment. The annotation supporting apparatus 100, which is the information processing apparatus, includes various modules shown in the figure and control means (not shown). A program for implementing the software is stored in the ROM 102 or the HDD 104. The control means controls a program, instructs and manages various modules, and transfers data between modules.

An image acquisition portion 201 acquires a document image stored in the storage device such as the HDD 104 as an input image.

The character recognition portion 202 acquires an input text area representing a coordinate range of a text written in the input image, and an input text (character code string) written in the input text area.

A translation portion 203 translates each text into a predetermined language for each input text area, and acquires a translation text and a translation text area. Further, the translation portion 203 generates a translation image in which each translation text is drawn in the translation text area. The translation image is a document image having a layout similar to that of the input image.

A display portion 204 displays the input image, the translation image and various calculation results on the displaying unit 105.

A text selection portion 205 selects one or more consecutive characters in the translation text, and acquires them as a selection text.

A label selection portion 206 selects a type of label to be assigned based on a user operation.

A label assignation portion 207 assigns the label to the input text corresponding to the selection text.

A storage portion 208 stores the input text and the label in the HDD 104 as the storage device in association with each other.

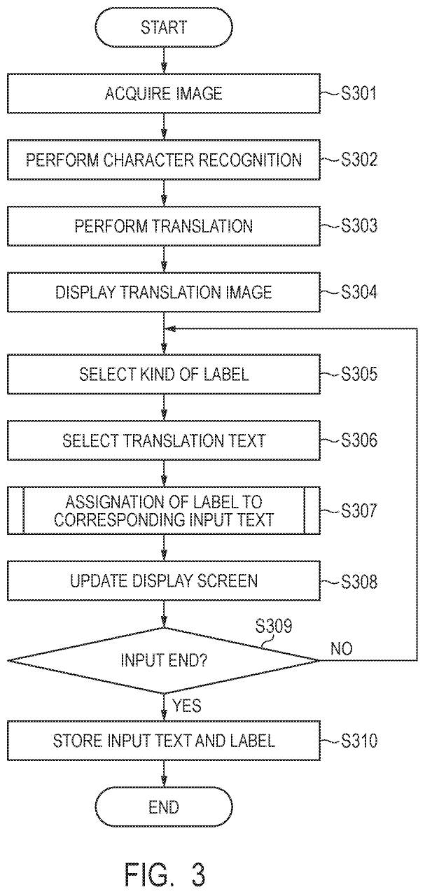

Next, a process flow of software of the information processing apparatus that realizes the present embodiment will be described with reference to FIG. 3. This process flow is implemented by the controlling unit 101 of the annotation supporting apparatus 100 developing a program stored in the ROM 102 or the HDD 104 into the RAM 103 and executing the program. Hereinafter, each step is denoted by “S”.

In S301, the image acquisition portion 201 acquires an input image to be processed captured from the scanner 107.

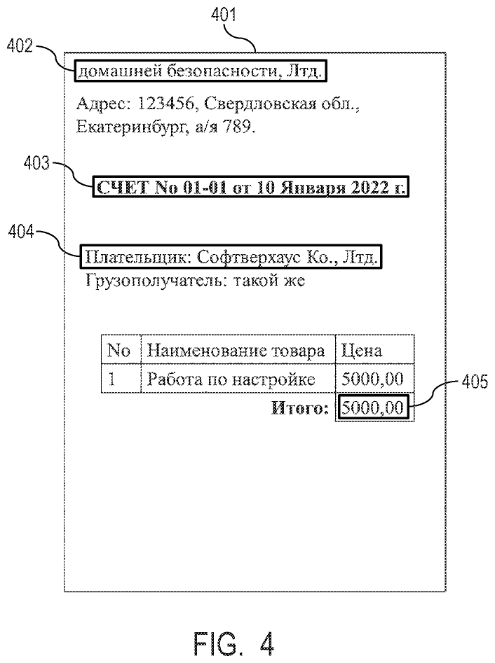

In S302, the character recognition portion 202 performs character recognition on the input image to acquire the input text area and the input text. The input image and the input text area in the present embodiment will be described with reference to a specific example in FIG. 4.

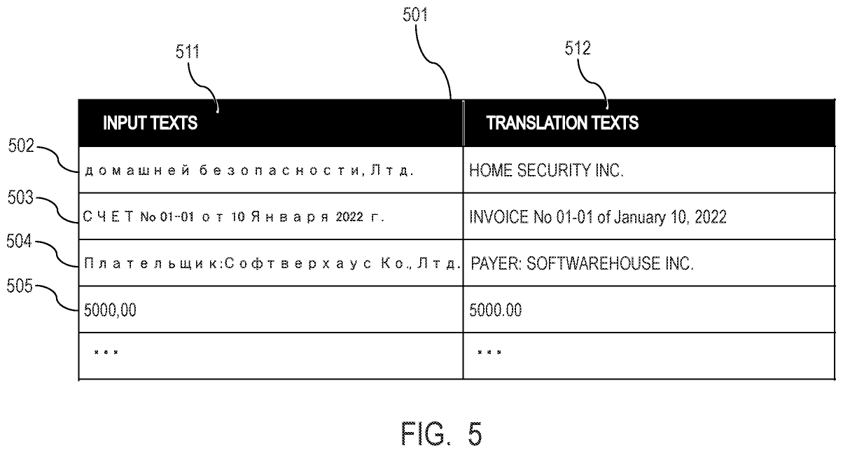

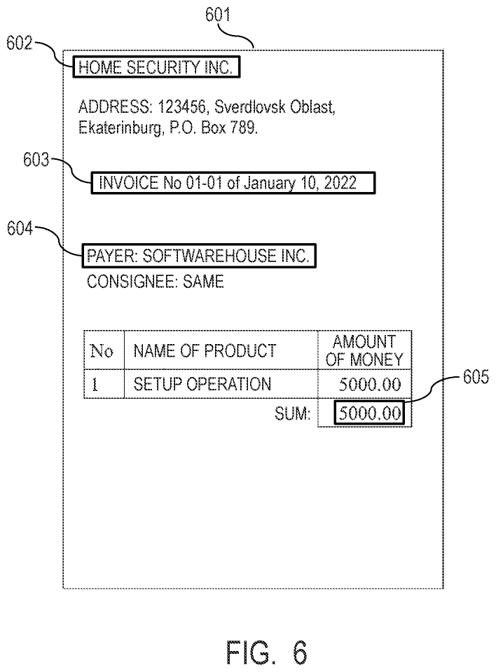

In S303, the translation portion 203 translates each input text for each input text area. Thus, the translation portion 203 acquires the translation text area and the translation text corresponding to each input text area. Further, the translation portion 203 generates a translation image in which the translation text is drawn at a position of each translation text area of an image having the same size as the input image. The translation text, the translation text area and the translation image will be described with reference to specific examples in FIGS. 5 and 6.

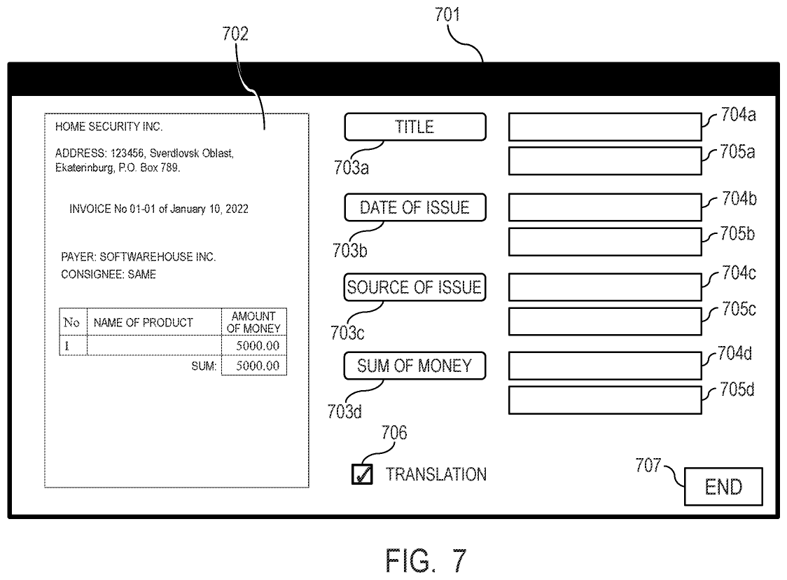

In S304, the display portion 204 displays a display screen including the translation image on the displaying unit 105. The display screen will be described with reference to a specific example in FIG. 7.

In S305, the label selection portion 206 selects the type of label to be assigned based on the user operation.

Next, in S306, the text selection portion 205 selects an arbitrary translation text on the display screen in units of consecutive characters based on the user operation, and acquires the text as the selection text. It is assumed that the selection text is a translation text corresponding to a text which is originally desired to be assigned with a label in the input image.

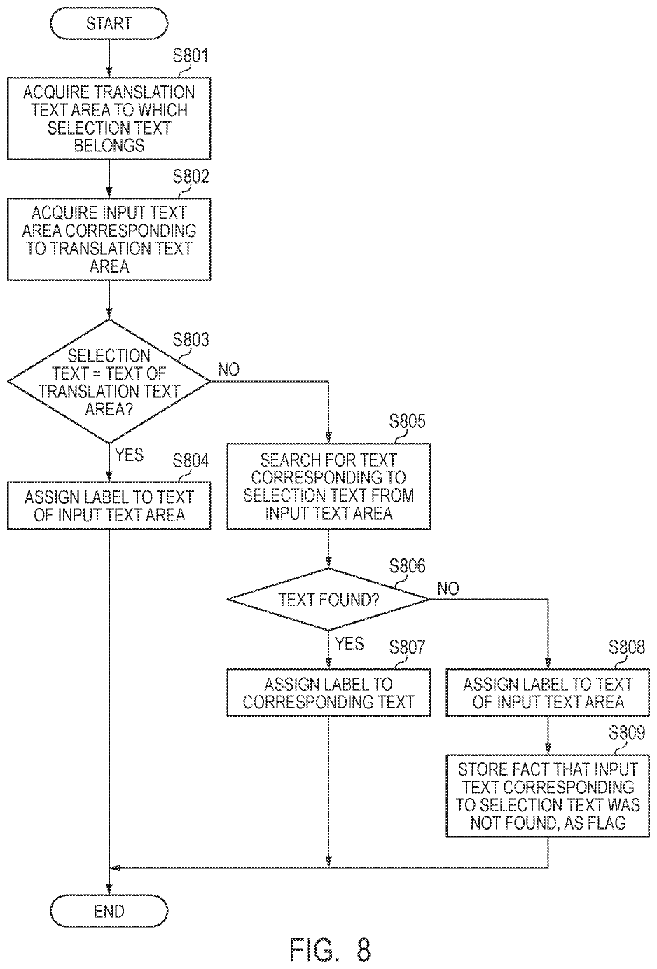

Next, in S307, the label assignation portion 207 assigns the label to the input text corresponding to the selection text. The details of such a label assigning process will be described later with reference to FIG. 8 to FIG. 11B.

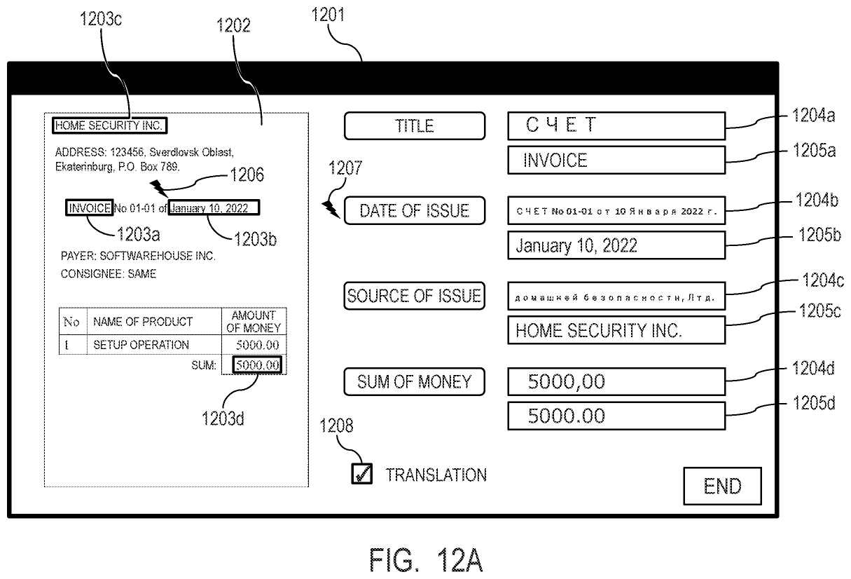

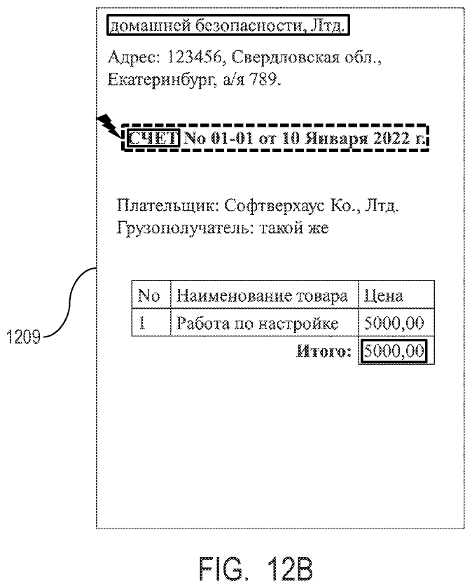

Next, in S308, the display portion 204 updates the display screen. The updated display screen will be described with reference to specific examples in FIGS. 12A and 12B.

Next, in S309, the control unit determines whether or not the input is finished, and when the input is finished, the process proceeds to S310, and when the input is continued, the process proceeds to S305. For example, when an “end” button indicating the end on the display screen is selected, the control unit advances the process to S310.

Finally, in S310, the storage portion 208 stores the input text and the label in the storage device in association with each other.

FIG. 4 shows an example of the input image. Referring to FIG. 4, the input image and the input text area acquired in S301 to S302 will be described. In the present embodiment, the input text area is defined and described as a circumscribed rectangular area of text of one line.

An input image 401 is an invoice written in Russian. By character-recognizing the image, the input text area which is the circumscribed rectangle of the text described in the input image is acquired.

Here, in an input text area 402, the name of a company that issues the invoice is written.

In an input text area 403, a text indicating that the input image 401 is the invoice, an invoice number of the invoice, and a date of issue of the invoice are written.

In an input text area 404, the name of a company to which the invoice is issued (the invoice destination) is written.

In an input text area 405, the amount of money in the invoice is written.

The definition of the text area is not limited to the above. For example, a plurality of adjacent lines may be collectively used as a text area, or a specific symbol such as “:” may be used as a pause to further subdivide a text area.

A translation result list of FIG. 5 is shown as a table composed of the input texts and the corresponding translation texts. Referring to FIG. 5, the input texts and the translation texts acquired in S302 to S303 will be described.

A translation result list 501 has, as attributes, input texts 511 and translation texts 512 acquired by translating the respective input texts 511 by the translation portion 203. Each of input texts of translation results 502, 503, 504 and 505 is a character recognition result corresponding one-to-one to each of the input text areas 402, 403, 404 and 405 respectively.

The translation result 502 has the input text “ [symbol] e [symbol] [symbol] ” and the translation text “HOME SECURITY INC.” acquired by translating the input text.

Similarly, the translation result 503 has the input text “C [symbol] ET No 01-01 OT 10 [symbol] 2022 r.” and the translation text “INVOICE No 01-01 of January 10, 2022”.

The translation result 504 has the input text “Π [symbol] : Co [symbol] xayc [symbol] o., [symbol] .” and the translation text “PAYER: SOFTWAREHOUSE INC.”.

The translation result 505 has the input text “5000,00” and the translation text “5000.00”.

FIG. 6 shows the translation image generated in S303.

A translation image 601 is an image that is acquired by, using the translation portion 203, drawing each translation text of the translation result list 501 in the translation text area determined based on the corresponding input text area, with respect to a blank sheet image having the same size as the input image 401.

The translation text areas are drawn, for example, at the same upper left coordinates and height as the corresponding input text areas. In this case, although the widths of the rectangles do not match due to the difference in the number of characters of the input text and the translation text, the relative positional relationship between the input text areas and the relative positional relationship between the translation text areas are substantially equal to each other, resulting in a similar layout as a whole. By doing so, the annotator, which is the user, can easily grasp the correspondence relationship.

Translation text areas 602, 603, 604 and 605 correspond one-to-one to the translation results 502, 503, 504 and 505.

FIG. 7 shows the display screen displayed in S304.

A display screen 701 includes a display image 702, label type selection buttons 703a, 703b, 703c and 703d, input text boxes 704a, 704b, 704c and 704d, translation text boxes 705a, 705b, 705c and 705d, a translation switch 706, and an end button 707.

The display image 702 displays either the input image 401 or the translation image 601. The displaying between the input image 401 and the translation image 601 is switched by turning on/off the check of the checkbox-type translation switch 706. Further, by performing mouse scrolling, a swipe operation, a pinch-in/pinch-out operation or the like on the display image 702, the display area can be changed, that is, a display range or a display magnification can be changed.

The annotator, which is the user of the apparatus, selects the translation text by selecting arbitrary consecutive characters on the image in a state in which the translation image 601 is displayed in the display image 702.

The label type selection buttons 703a to 703d are buttons for displaying the label type names being the targets of the annotation supporting apparatus in the present embodiment, and selecting the labels to be assigned.

On the display screen 701, the “title” is displayed on the label type selection button 703a, the “date of issue” is displayed on the label type selection button 703b, the “source of issue” is displayed on the label type selection button 703c, and the “sum of money” is displayed on the label type selection button 703d. The label selection portion 206 selects a label to be assigned, by the user pressing each label type selection button. In the present embodiment, the user presses the button, but the present disclosure is not limited to the button, and the button may be selected by another user operation.

The input text boxes 704a to 704d are text boxes in which the input texts (texts in the input image) to which the labels are assigned are displayed respectively.

The translation text boxes 705a to 705d are text boxes in which the translation texts corresponding to the input texts with the labels assigned are displayed respectively.

The end button 707 is a button for ending the annotation work. When the annotation of all the labels is finished, the annotator, which is the user of the apparatus, presses the end button 707. As a result, it is determined in S309 that the input ends.

FIG. 8 is the flow chart showing the label assigning process in S307.

In S801, the label assignation portion 207 acquires the translation text area to which the selection text selected in S304 belongs.

In S802, the label assignation portion 207 acquires the input text area corresponding to the translation text area acquired in S801.

In S803, the label assignation portion 207 confirms whether or not the selection text matches the entire text of the translation text area to which the selection text belongs. When they match, the process proceeds to S804, and when they do not match, the process proceeds to S805.

In S804, the label assignation portion 207 assigns the label selected by the label selection portion 206 to the text of the input text area acquired in S802, and ends the process.

In S805, the label assignation portion 207 searches for the text (the character string) corresponding to the selection text from the text of the input text area acquired in S802.

For example, when the selection text is “INVOICE” with respect to the translation text “INVOICE No 01-01 of January 10, 2022” of the input text “C [symbol] ET No 01-01 oT 10 [symbol] 2022 r.”, the character string “C [symbol] ET” as its translation source is specified and acquired. The search process can be realized by a method of creating word correspondences between languages in advance, a method of converting a word using the “Word2vec” into a feature vector and searching for a word with the closest distance (similar meanings), or the like.

In S806, the label assignation portion 207 determines whether or not the corresponding character string is found, and when it is found, the process proceeds to S807, and when it is not found, the process proceeds to S808.

In S807, the label assignation portion 207 assigns the label selected by the label selection portion 206 to the input text corresponding to the translation text, and ends the process.

In S808, the label assignation portion 207 assigns the label selected by the label selection portion 206 to the entire text of the input text area acquired in S802.

In S809, the label assignation portion 207 stores as a flag the fact that the input text corresponding to the selection text was not found, and ends the process.

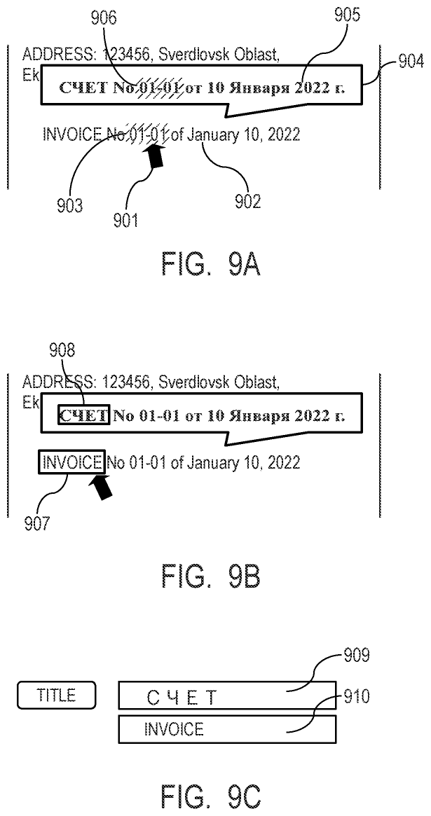

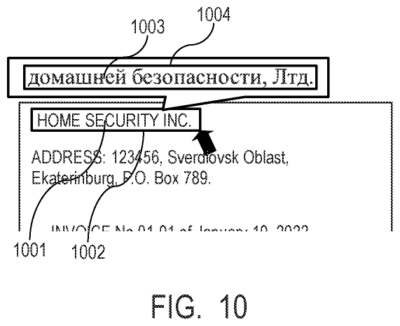

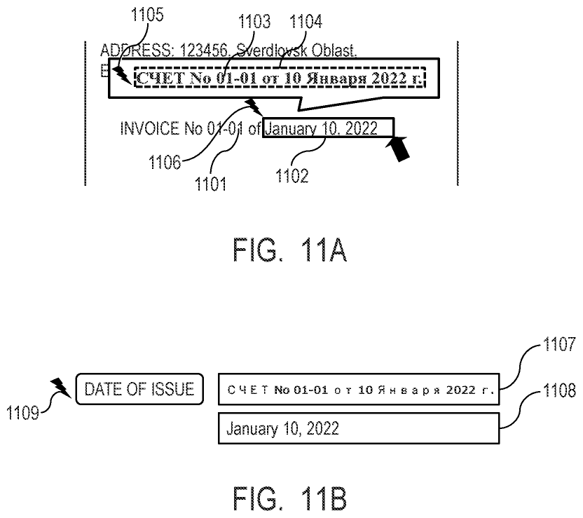

Next, with reference to FIGS. 9A to 11B, the processes (the text selection to the label assigning process) in S306 to S308 will be described with a specific example. Note that in FIGS. 9A to 9C the case of passing through S807 in S307 will be described, in FIG. 10 the case of passing through S804 will be described, and in FIGS. 11A and 11B the case of passing through S808 will be described.

FIG. 9A shows an enlarged screen of a part of the display image 702. Here, it is assumed that the “title” is selected as the type of label to be assigned. The annotator operates a cursor 901 to select arbitrary translation text area and translation text on the display image 702.

In FIG. 9A, the cursor 901 is located within a translation text area 902. The translation text area 902 is equal to the translation text area 603 shown in FIG. 6. At this time, the display portion 204 displays, on a pop-up window 904, a trimming image 905 acquired by trimming the input text area (equal to the input text area 403) corresponding to the translation text area 902 to which the cursor 901 is touching from the input image.

The pop-up window 904 is displayed at a position near and not overlapping the target translation text area 902. Further, since the cursor 901 is located on a partial character string 903 (text “01-01”) in the translation text area 902, a partial character string 906 (text “01-01”) of the input text corresponding to the partial character string 903 is highlighted.

The acquisition of the partial character string can be realized by divisionally writing the translation text. The search of the input text corresponding to the divisionally written translation text is realized by the method using the label assignation portion 207 described in S805.

In FIG. 9B, the text “INVOICE” is selected as the selection text, and a selection frame 907 representing the selection text is displayed. Further, the input text “C [symbol] ET” corresponding to the text “INVOICE” is selected, and a selection frame 908 is similarly displayed. As a result, the “title” label is assigned to the input text “C [symbol] ET”.

FIG. 9C shows a screen displaying a result of the assignation of the “title” label. On the display screen 701, the selection text “INVOICE” selected in FIG. 9B and the input text “C [symbol] ET” corresponding to the selection text are displayed in a translation text box 910 and an input text box 909 of the label “title”, respectively.

FIG. 10 shows a part of the display image 702. Here, it is assumed that the “source of issue” is selected as the type of label to be assigned. A translation text area 1001 is equal to the translation text area 602 shown in FIG. 6, and a corresponding input text area 1003 is equal to the input text area 402 shown in FIG. 4.

In FIG. 10, the text “HOME SECURITY INC.” is selected by the annotator, and a selection frame 1002 is displayed. The text selected matches, as shown in FIG. 5, the entire text included in the translation text area 1001. Therefore, the input text area 1003 corresponding to the translation text area 1001 is acquired as the corresponding area, and a selection frame 1004 is displayed.

FIG. 11A shows a part of the display image 702, and it is assumed that the “date of issue” is selected as the label to be assigned. A translation text area 1101 is equal to the translation text area 603 shown in FIG. 6, and a corresponding input text area 1103 is equal to the input text area 403 shown in FIG. 4.

In FIG. 11A, the text “Jan. 10, 2022” is selected by the annotator, and a selection frame 1102 is displayed. On the other hand, it is assumed that the label assignation portion 207 searches for the corresponding input text (i.e., association), but the association has been failed. In this case, the entire text in the corresponding input text area 1103 is acquired as a corresponding character string.

A selection frame 1104 is displayed differently from the selection frame 908 and the selection frame 1004 (i.e., displayed with a broken line in the example) so that the user can visually recognize that the association has been failed, and moreover icons 1105 and 1106 are displayed in order to emphasize such a fact.

FIG. 11B shows a screen for displaying the result of the assignation of the “date of issue” label. On the display screen 701, the selection text “Jan. 10, 2022” selected in FIG. 11A is displayed in a translation text box 1108, and the text in the input text area 1103 is displayed in an input text box 1107.

The contents of the translation text box 1108 and the input text box 1107 are in the failure state of association, and they do not match semantically. Therefore, an icon 1109 indicating that the association has been failed is displayed.

FIG. 12A shows a display screen displayed by the display portion 204 in S308. On a display screen 1201, a result of assignation of each label is displayed. A display image 1202 is an image in which selection frames 1203a, 1203b, 1203c and 1203d representing selection texts for respective labels and an icon 1206 indicating that the selection text has failed to be associated with the input text are superimposed on the translation image 601.

In translation text boxes 1205a, 1205b, 1205c and 1205d, the selection texts for the respective labels selected on the translation image 601 are displayed. In input text boxes 1204a, 1204b, 1204c and 1204d, the input texts on the input image 401 corresponding to the respective selection texts are displayed. Among them, for the “date of issue” label, the contents of the translation text box 1205b and the input text box 1204b do not match semantically. This is because the label assignation portion 207 has failed the association, and an icon 1207 indicating this fact is displayed.

Here, a display image 1209 shown in FIG. 12B is displayed by removing the check of a translation switch 1208 and switching the display image 1202. The display image 1209 is an image acquired by superimposing each selection frame and icon on the input image 401.

### Second Embodiment

In the first embodiment, it is premised that all the annotations are performed on the translation image. In the second embodiment, the annotation can also be performed on the input image. The displaying of the input image can be performed by switching the displaying using the translation switch 706. The annotation for the translation text area may be performed on a pop-up window displayed when a cursor is touched to the input text area on the input image.

When the annotation for the input image is performed, in case of newly selecting a text, the text selection portion 205 selects the text from the input text area, and the label assignation portion 207 searches for the corresponding translation text from the selected input text. Displaying of the result can be realized by replacing the input information and the translation information and performing the process, in the same procedure as in the first embodiment.

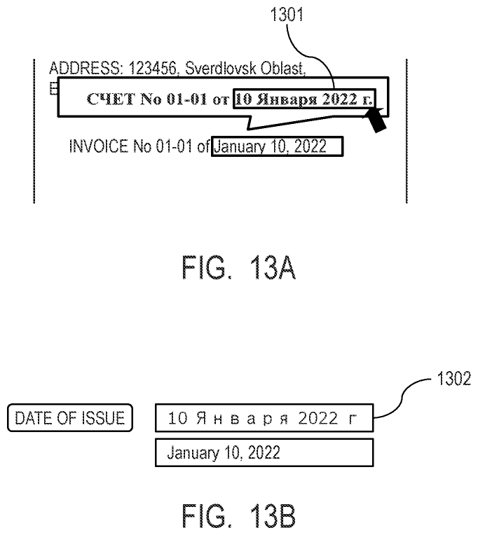

Further, there is already a text area selected on the translated image, and the text area on the corresponding input image can be corrected. Here, the process of correcting the text area of the “date of issue” label shown in FIG. 11B on the pop-up window will now be described with reference to FIGS. 13A and 13B.

First, the four corners of the selection frame 1104 shown in FIG. 11A are dragged and modified into a selection frame 1301 shown in FIG. 13A. At this time, in the selection frame 1102 selected on the translation image, updating by the label assignation portion 207 is not performed because of the area explicitly selected by the annotator.

The icon 1105 indicating failure of association failure is deleted since the correction operation by the annotator is performed. The screen for displaying the label assignation result is updated to a text selected as shown in a translation text box 1302 of FIG. 13B, and the icon 1109 indicating the failure of association is deleted.

### Third Embodiment

In the first embodiment, the entire image displaying of the input image and the translation image is switched by the translation switch 706. In the third embodiment, both the input image and the translation image are displayed side by side in their entirety on the same screen, thereby improving workability.

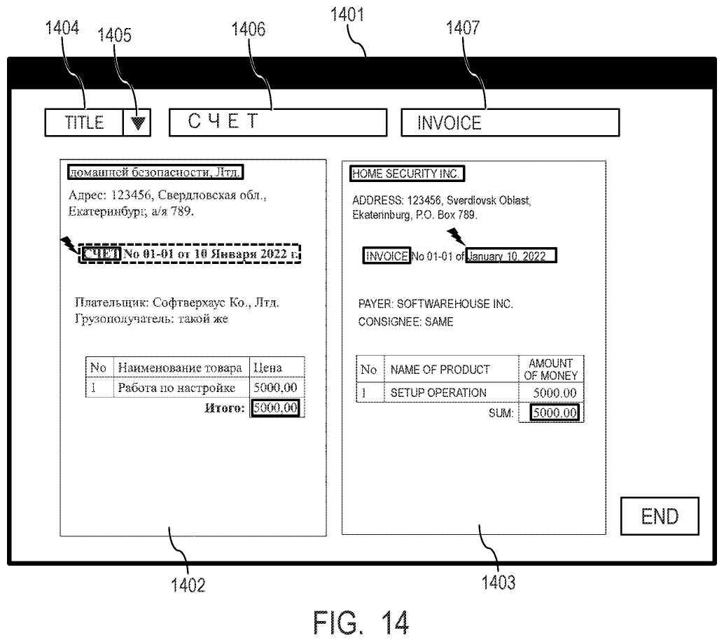

FIG. 14 is a diagram showing an example of a screen displaying an input image 1402 and a translation image 1403 on a display screen 1401.

The display screen 1401 includes a label type text 1404, a label switching button 1405, an input text box 1406, and a translation text box 1407. The label type text 1404 displays the name of a label type to be displayed and assigned, and the relevant name can be switched by the label switching button 1405. The display contents of the input text box 1406 and the translation text box 1407 are the same as those in the first embodiment. On the display screen 1401, the contents displayed in the pop-up window in the first embodiment are displayed on the other entire image.

As described above, in the first to third embodiments, it is possible to assign the label to the text of the input image by the annotator selecting the label and then selecting the translation text acquired by translating the text of the input image. Therefore, it is possible to reduce annotation operation costs in a case where the annotator is not familiar with the language described in the document.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-203058, filed Dec. 20, 2022, which is hereby incorporated by reference herein in its entirety.

What is claimed is:

1. An information processing apparatus comprising:
at least one memory that stores instructions; and
at least one processor that executes the instructions to:
acquire a translation text by executing a translation process on an input text;
select one or more consecutive characters in the translation text as a selection text, based on a user operation;
assign a label selected based on a user operation, to a character string corresponding to the selection text in the input text; and
store the input text to which the label has been assigned, in a storage unit.

2. The information processing apparatus according to claim 1,
wherein the at least one processor executes the instructions further to:
acquire an input image;
acquire the input text and an input text area representing a coordinate range of the input text, by executing a character recognition process on the input image; and
display, based on the translation text and the input text area, a translation image generated by drawing the translation text to a layout similar to that of the input image, on a display,
wherein the selection text is selected by the user operation on the translation image displayed on the display.

3. The information processing apparatus according to claim 2,
wherein the at least one processor executes the instructions further to:
acquire, in the translation process, a translation text area by executing translation for each input text area; and
assign, in a case where the selection text matches an entire text of the translation text area to which the selection text belongs, the selected label to an entire text of the input text area corresponding to the translation text area selected based on the user operation.

4. The information processing apparatus according to claim 2,
wherein the at least one processor executes the instructions further to:
acquire, in the translation process, a translation text area by executing translation for each input text area;
search for the character string corresponding to the selection text from a text of the input text area corresponding to the translation text area to which the selection text belongs; and
assign, in a case where the character string corresponding to the selection text is found, the selected label to the found character string.

5. The information processing apparatus according to claim 2,
wherein the at least one processor executes the instructions further to:
acquire, in the translation process, a translation text area by executing translation for each input text area;
search for the character string corresponding to the selection text from a text of the input text area corresponding to the translation text area to which the selection text belongs; and
assign, in a case where the character string corresponding to the selection text is not found, the label to an entire text of the input text area corresponding to the translation text area to which the selection text belongs, and further assign a flag.

6. The information processing apparatus according to claim 2,
wherein the at least one processor executes the instructions further to:
display an image acquired by trimming from the input image the input text area corresponding to a translation text area to which the selection text belongs, at a position near the translation text area to which the selection text belongs.

7. The information processing apparatus according to claim 2,
wherein the at least one processor executes the instructions further to:
display, on the display, the input image and the translation image side by side in their entirety on a same screen.

8. A controlling method of an information processing apparatus, the controlling method comprising:
acquiring a translation text by executing a translation process on an input text;
selecting one or more consecutive characters in the translation text as a selection text, based on a user operation;
assigning a label selected based on a user operation, to a character string corresponding to the selection text in the input text; and
storing the input text to which the label has been assigned, in a storage unit.

9. A non-transitory computer-readable storage medium that stores a program of instructions wherein the instructions cause at least one processor to:
acquire a translation text by executing a translation process on an input text;
select one or more consecutive characters in the translation text as a selection text, based on a user operation;
assign a label selected based on a user operation, to a character string corresponding to the selection text in the input text; and
store the input text to which the label has been assigned, in a storage unit.
